(19) United States
(12) Patent Application Publication
(10) Pub. No.: US 2023/0099539 A1
(43) Pub. Date: Mar. 30, 2023

(54) METHODS AND DEVICES FOR IMAGE RESTORATION USING SUB-BAND SPECIFIC TRANSFORM DOMAIN LEARNING

(71) Applicant: KWAI INC., Palo Alto, CA (US)

(72) Inventors: Paras MAHARJAN, Kansas City, MO (US); Ning XU, Irvine, CA (US); Xuan XU, Palo Alto, CA (US); Yuyan SONG, Palo Alto, CA (US)

(73) Assignee: KWAI INC., Palo Alto, CA (US)

(21) Appl. No.: 17/491,516

(22) Filed: Sep. 30, 2021

(51) Int. Cl. G06T 5/10; G06T 5/50; G06N 3/02

(52) U.S. Cl. CPC G06T 5/10; G06T 5/50; G06N 3/02; G06T 2207/20052; G06T 2207/20084; G06T 2207/20212; G06T 2207/20081

(57) ABSTRACT

A method, apparatus, and a non-transitory computer-readable storage medium for sub-band image reconstruction. The method may include obtaining an image captured by a camera. The method may also obtain a transform image based on the image captured by the camera. The transform image may be in a transform domain. The method may further obtain decomposed image components of the transform image. The decomposed image components may include a low frequency component and at least one high frequency component. The method may also obtain a reconstructed image based on at least two neural networks processing the decomposed image components in the transform domain

### TECHNICAL FIELD

This disclosure is related to image processing. More specifically, this disclosure relates to methods and apparatus for image reconstruction.

### BACKGROUND

Image restoration is the process of enhancing and improving the quality of the degraded image. Image gets degraded from various sources like noise (shot noise, read noise, quantization noise), motion blur, compression artifacts, etc. Hence the image restoration is essential stage in imaging/video system for quality image reproduction for better visual perception. A method of image restoration in transform domain is proposed. The method may focus on image deblocking and image deblurring.

Traditional based optimization methods are difficult to implement for real world reconstruction because of the model complexity, and inefficiency in handling large variation of degradation. Currently, deep learning-based method has shown promising result in such restoration task. Usually in deep learning, most of the learning task works on spatial domain. Network extracts and learns the feature directly from the RGB input image. Whether a reconstruction, classification, recognition, input image is still processed in spatial domain. In addition, if the high frequency information is heavily suppressed by the degradation these deep neural network tends to smooth the output and hence removing the details from the final image.

### SUMMARY

Examples of the present disclosure provide methods and apparatus for sub-band image reconstruction.

According to a first aspect of the present disclosure, a method for sub-band image reconstruction. The method may include obtaining an image captured by a camera. The method may also obtain a transform image based on the image captured by the camera. The transform image may be in a transform domain. The method may also obtain decomposed image components of the transform image. The decomposed image components may include a low frequency component and at least one high frequency component. The method may further obtain a reconstructed image based on at least two neural networks processing the decomposed image components in the transform domain.

According to a second aspect of the present disclosure, a computing device is provided. The computing device may include one or more processors, a non-transitory computer-readable memory storing instructions executable by the one or more processors coupled with a camera. The one or more processors may be configured to obtain an image captured by the camera. The one or more processors may be further configured to obtain a transform image based on the image captured by the camera. The transform image may be in a transform domain. The one or more processors may also be configured to obtain decomposed image components of the transform image. The decomposed image components may include a low frequency component and at least one high frequency component. The one or more processors may be configured to obtain a reconstructed image based on at least two neural networks processing the decomposed image components in the transform domain.

According to a third aspect of the present disclosure, a non-transitory computer-readable storage medium having stored therein instructions is provided. When the instructions are executed by one or more processors of the apparatus, the instructions may cause the apparatus to obtain an image captured by a camera. The instructions may also cause the apparatus to obtain a transform image based on the image captured by the camera. The transform image is in a transform domain. The instructions may also cause the apparatus to obtain decomposed image components of the transform image. The decomposed image components may include a low frequency component and at least one high frequency component. The instructions may also cause the apparatus to obtain a reconstructed image based on at least two neural networks processing the decomposed image components in the transform domain

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1A is an input image, according to an example of the present disclosure.

FIG. 1B is an illustration of an image after applying a 4×4 Discrete Cosine Transform (DCT), according to an example of the present disclosure.

FIG. 2A is an illustration of a network overview, according to an example of the present disclosure.

FIG. 2B is an illustration of a DCT residual net (ResNet), according to an example of the present disclosure.

FIG. 2C is an illustration of a residual block (ResBlock), according to an example of the present disclosure.

FIG. 3A is an illustration of a network, according to an example of the present disclosure.

FIG. 3B is an illustration of a DCT ResNet, according to an example of the present disclosure.

FIG. 3C is an illustration of a ResBlock, according to an example of the present disclosure.

FIG. 4 is a method for sub-band image reconstruction, according to an example of the present disclosure.

FIG. 5 is a method for sub-band image reconstruction, according to an example of the present disclosure.

FIG. 6 is a diagram illustrating a computing environment coupled with a user interface, according to an example of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the term “and/or” used herein is intended to signify and include any or all possible combinations of one or more of the associated listed items.

It shall be understood that, although the terms “first,” “second,” “third,” etc., may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to a judgment” depending on the context.

The disclosure provides a transform domain used for sub-band specific processing for single image reconstruction. This disclosure is not limited to image deblocking and image deblurring but can be implemented to any image restoration task like denoising, demoireing, deraining, etc.

Multi-level wavelet convolutional network (MWCNN) uses the transform domain for restoration tasks. It used Discrete Wavelet transform (DWT) and Inverse Wavelet Transform (IWT) as down-scaling and up-scaling layer. However, the final output of the network is still in spatial domain. This mean the neural network is still learning in spatial domain.

Image restoration is driven by spatial loss though it uses wavelet decomposition for feature extraction. This results in limited performance since it is difficult to scale the network because of the limitation in wavelet transform integrate inside network.

Residual channel attention networks (RCAN) modify the residual net (ResNet) and introduce the channel attention for image restoration task. RCAN process the image in spatial domain. That is RCAN performs restoration in spatial domain which makes it difficult to train and creates a longer inference time because of large network parameters.

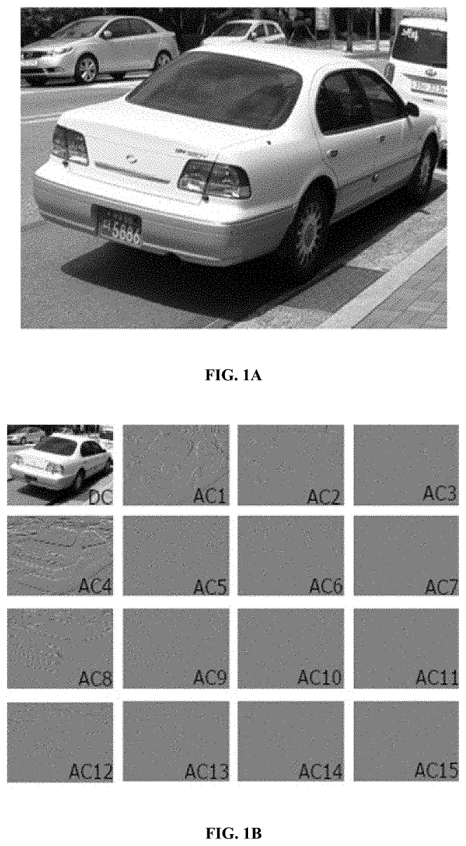

In one or more embodiments, it is proposed to use a 4×4 Discrete Cosine Transform (DCT) as a primary decomposition method to decompose image to its low-frequency and high-frequency component. The resulting DCT image subsampled to its respective sub-bands to form 16 DCT sub-band images which is then used as input to a network. A total of 48 channel DCT image was formed by concatenating the 16 sub-bands for each “R,” “G,” and “B” color channels. FIG. 1B shows the 4×4 decomposition for a single color channel of image in FIG. 1A.

FIG. 1A shows an input image. The image shows a picture captured by a camera.

FIG. 1B shows an image after applying 4×4 DCT on R channel of the input image in FIG. 1A and then subsampled to 16 sub-band images represents low-frequency DC image and high-frequencies AC1-AC15 images. Sub-band images are ¼^{th} the resolution of input image.

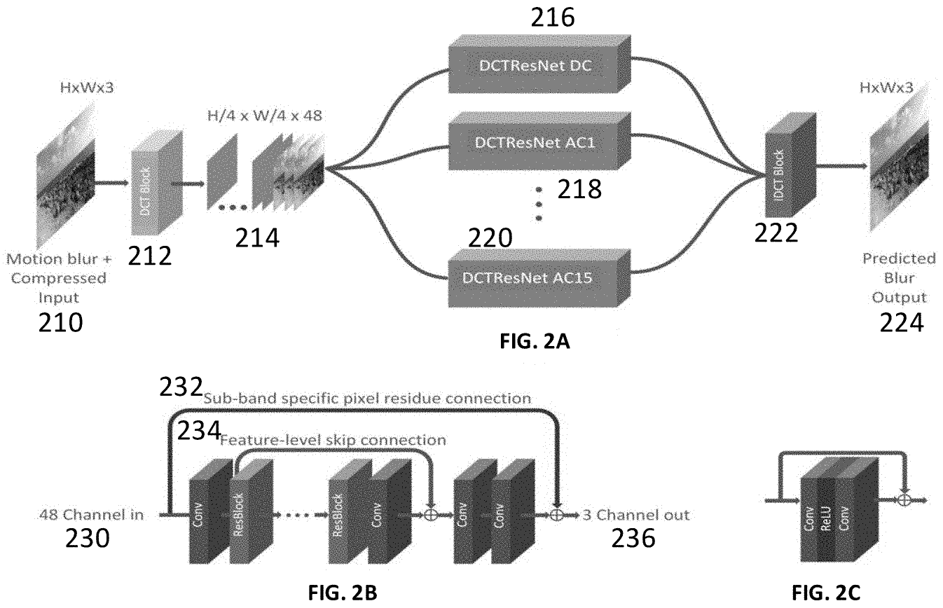

In one or more embodiments it is proposed to use a sub-band specific network for DC and ACs designed separately for image reconstruction. The overview one or more proposed DCTResNet is shown in the FIGS. 2A and 2B. The enhanced deep super-resolution network (EDSR) network is modified with sub-band specific pixel residue connection and learned the specific DCT sub-bands. During testing the output of these sub-band learning network is combined and inverse DCT (IDCT) is performed to reconstruct the clean RGB image.

FIG. 2A shows Network architecture of DCTResNet. Specifically, FIG. 2A shows a motion blur+compressed input 210 with H×W×3, DCT Block 212, images 214 with H/4×W/4×48, DCTResNet DC 216, DCTResNet AC1 218, DCTResNet AC15 220, IDCT Block 222, and predicted blur output 224 with H×W×3.

In FIG. 2A, RGB image transformed into transform domain using DCT transform. The DCT sub-band images are then used as input to a DCTResNet network. Pixel-level skip connection for learning each corresponding sub-band image.

FIG. 2B shows Architecture of DCTResNet, which consist of 20 residual blocks (ResBlocks) and 64 num of features. Specifically, FIG. 2B shows 48 inputs (channel in) 230, sub-band specific pixel residue connection 232, feature-level skip connection 234, and 3 outputs (channel out) 236.

FIG. 2C shows a structure of residual block. Specifically, FIG. 2C includes Cony and Rectified Linear Unit (ReLU).

Specifically for image deblocking, DCT decomposition helps to learn Joint Photographic Experts Group (JPEG) compression prior to effectively correct the blocking artifacts. Since, the 4×4 DCT sub-band image is ¼^{th} the size of the original image, the effective receptive field is much larger than the prior methods.

Sub-band specific network helps in better reconstruction of sub-band images. This specially helps in better reconstruction of high frequency component as a dedicated AC network is use for reconstruction of high frequency component.

In one or more embodiment, it is proposed to, instead of separately training the AC sub-bands for each sub-band, all the AC components are grouped together and a single AC network is trained to process all the AC component. This helps to minimize the complexity of the network while still maintaining better performance. Furthermore, channel attention may be added in a EDSR backbone network to help further improve performance.

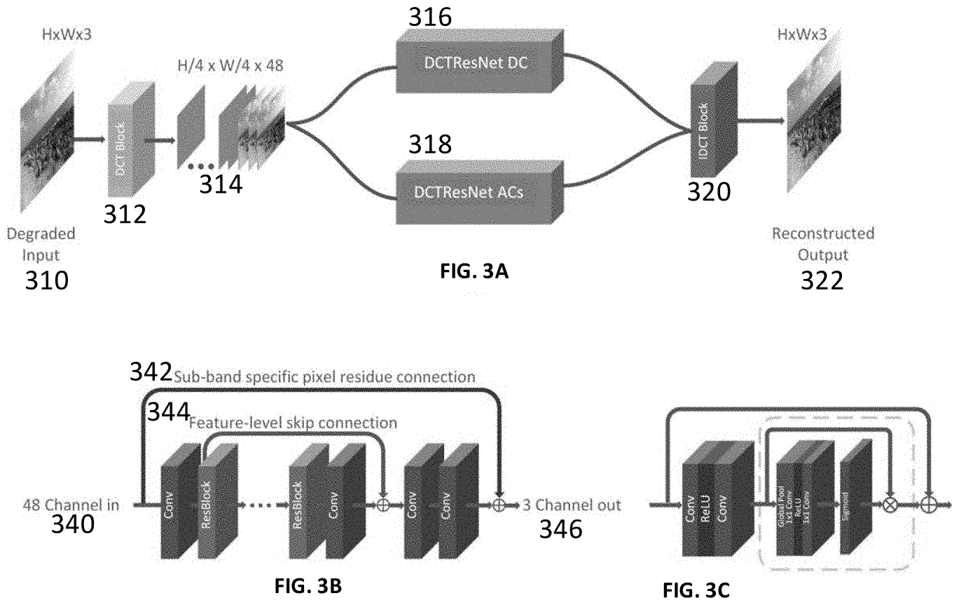

FIG. 3A shows Network architecture of DCTResNet. Specifically, FIG. 3A shows degraded input 310 with H×W×3 dimensions, DCT Block 312, images 314 with H/4×W/4×48 dimensions, DCTResNet DC 316, DCTResNet ACs 318, IDCT Block 320, and reconstructed output 322 with H×W×3 dimensions.

In FIG. 3A, RGB image transformed into transform domain using DCT transform. The DCT sub-band images are then used as input to a DCTResNet network. Pixel-level skip connection for learning each corresponding sub-band image only for DC sub-band learning.

FIG. 3B shows Architecture of DCTResNet, which consists of 64 ResBlocks and 256 num of features. Specifically, FIG. 3b shows 48 inputs (channel in) 340, sub-band specific pixel residue connection 342, feature-level skip connection 344, and 3 outputs (channel out) 346.

FIG. 3C shows Structure of residual block with Channel Attention (CA). FIG. 3C. includes Cony, ReLU, global pool, 1×1 cony, and sigmoid.

The IDCT section can also be replaced by the deep learning network that learns the RGB image from reconstructed sub-band image.

A shallow network can be implemented at the end with spatial domain as the post processing to enhance the performance of the network.

In one or more embodiments, it is proposed to process image in transform domain and utilizes the sub-band specific image reconstruction.

Separate networks are trained for separate sub-bands. Having this sub-band specific learning specially helps to learn the sub-band individually resulting in better learning of low and high frequency information.

Final image is reconstructed by combining the reconstructed sub-band images.

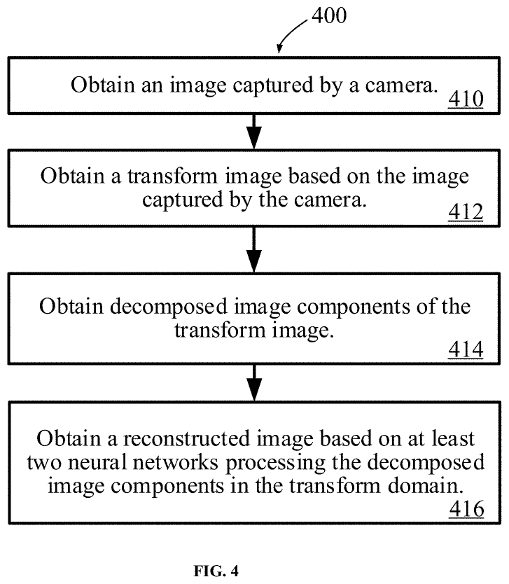

FIG. 4 shows a method for sub-band image reconstruction in accordance with the present disclosure. The method may be implemented by a device include one or more processors such as CPUs and/or GPUs. For example, the device may be a smart phone, a tablet, a smart glass, a computer, a server, or any other electronic device.

In step 410, the device obtains an image captured by a camera. The camera may be included as a part of the device. Alternatively, or additionally, the camera may be wirelessly connected with the device.

In step 420, the device obtains a transform image based on the image captured by the camera. The transform image is in a transform domain. The transform image, for example, may be obtained using Fourier transform, Laplace transform, Discrete Wavelet transform (DWT), Inverse Wavelet Transform (IWT), Discrete Cosine Transform (DCT), or other transforms.

In step 430, the device obtains decomposed image components of the transform image. The decomposed image components comprise a low frequency component and at least one high frequency component. For example, the decomposed image components may be obtained using a DCT. In one or more examples, the decomposed image components may be obtained using a modified DCT (MDCT), discrete sine transform (DST), Multidimensional DCTs (MD DCTs) or other types of transforms.

In step 440, the device obtains a reconstructed image based on at least two neural networks processing the decomposed image components in the transform domain. For example, the decomposed image components may include a DC component and 15 AC components and each component is processed by a neural network trained to process that specific component. For example, a first neural network will process the DC component and the sixteenth neural network will process the fifteenth AC component. In another example, a neural network may be trained to process the DC component and a separate neural network may be trained to process the AC components, either all together or broken into groups.

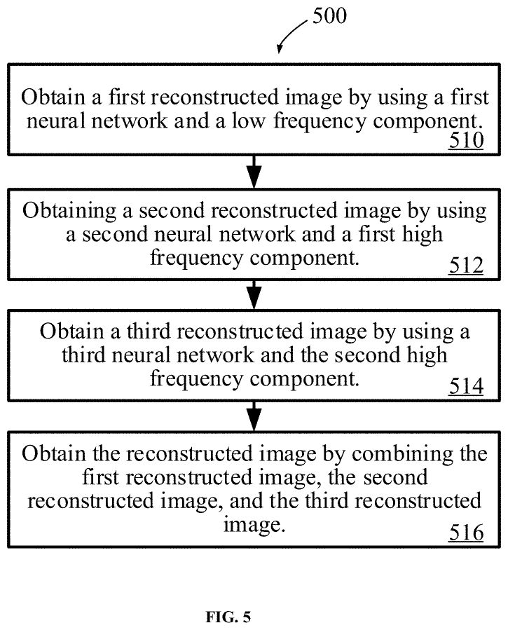

FIG. 5 shows a method for sub-band image reconstruction in accordance with the present disclosure. The method may be implemented by a device include one or more processors such as CPUs and/or GPUs.

In step 510, the device obtains a first reconstructed image by using a first neural network and the low frequency component.

In step 520, the device obtains a second reconstructed image by using a second neural network and a first high frequency component. The at least one high frequency component may include the first high frequency component and a second high frequency component.

In step 530, the device obtains a third reconstructed image by using a third neural network and the second high frequency component.

In step 540, the device obtains the reconstructed image by combining the first reconstructed image, the second reconstructed image, and the third reconstructed image.

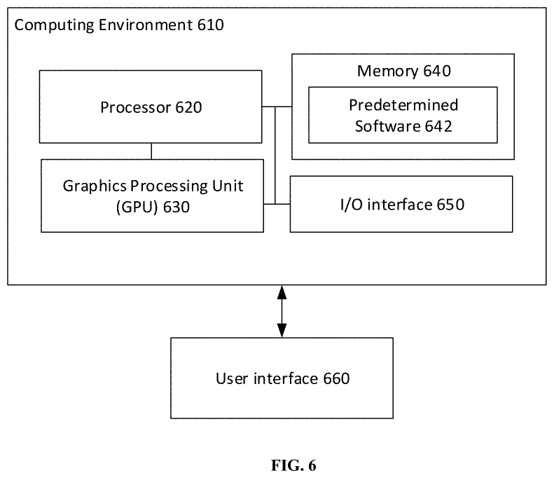

FIG. 6 shows a computing environment 610 coupled with user interface 660. Computing environment 610 includes processor 620, graphics processing unit (GPU) 630, memory 640, and I/O interface 650.

The processing component 620 typically controls overall operations of the computing environment 610, such as the operations associated with display, data acquisition, data communications, and image processing. The processor 620 may include one or more processors to execute instructions to perform all or some of the steps in the above described methods. Moreover, the processor 620 may include one or more modules which facilitate the interaction between the processor 620 and other components. The processor may be a Central Processing Unit (CPU), a microprocessor, a single chip machine, a GPU, or the like. GPU 630 can include one or more GPUs interconnected to execute one or more GPU executable programs.

The memory 640 is configured to store various types of data to support the operation of the computing environment 610. Examples of such data comprise instructions for any applications or methods operated on the computing environment 610, image data, etc. The memory 640 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 650 provides an interface between the processor 620 and peripheral interface modules, such as a keyboard, a click wheel, buttons, and the like. The buttons may include, but are not limited to, a home button, a start scan button, and a stop scan button.

In an embodiment, the computing environment 610 may be implemented with one or more application specific integrated circuits (ASICs), digital signal processors (DSPs), digital signal processing devices (DSPDs), programmable logic devices (PLDs), field programmable gate arrays (FPGAs), graphical processing units (GPUs), controllers, micro-controllers, microprocessors, or other electronic components, for performing the above methods.

In an embodiment, there is also provided a non-transitory computer-readable storage medium comprising instructions, such as comprised in the memory 640, executable by the processor 620 in the computing environment 610, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing environment 610 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for sub-band image reconstruction comprising:
obtaining an image captured by a camera;
obtaining a transform image based on the image captured by the camera, wherein the transform image is in a transform domain;
obtaining decomposed image components of the transform image, wherein the decomposed image components comprise a low frequency component and at least one high frequency component; and
obtaining a reconstructed image based on at least two neural networks processing the decomposed image components in the transform domain.

2. The method of claim 1, wherein obtaining the transform image based on the image captured by the camera comprises:
obtaining an image in the transform domain using a Discrete Cosine Transform (DCT).

3. The method of claim 2, further comprising:
obtaining a clean reconstructed image by Inverse Discrete Cosine Transform (IDCT) the reconstructed image.

4. The method of claim 1, wherein obtaining the reconstructed image based on the at least two neural networks processing the decomposed image components in the transform domain comprises:
obtaining a first reconstructed image by using a first neural network and the low frequency component;
obtaining a second reconstructed image by using a second neural network and the at least one high frequency component; and
obtaining the reconstructed image by combining the first reconstructed image and the second reconstructed image.

5. The method of claim 1, wherein obtaining the reconstructed image based on the at least two neural networks processing the decomposed image components in the transform domain comprises:
obtaining a first reconstructed image by using a first neural network and the low frequency component;
obtaining a second reconstructed image by using a second neural network and a first high frequency component, wherein the at least one high frequency component comprises the first high frequency component and a second high frequency component;
obtaining a third reconstructed image by using a third neural network and the second high frequency component; and
obtaining the reconstructed image by combining the first reconstructed image, the second reconstructed image, and the third reconstructed image.

6. The method of claim 1, wherein the at least one high frequency component comprises 15 high frequency components and the at least two neural networks comprise 16 neural networks.

7. The method of claim 1, wherein the at least two neural networks comprise a modified Enhanced Deep Super-Resolution (EDSR) network, wherein the modified EDSR network is modified to process a frequency component using a specific pixel residue connection.

8. A computing device comprising:
one or more processors couple with a camera; and
a non-transitory computer-readable memory storing instructions executable by the one or more processors, wherein the one or more processors are configured to:
obtain an image captured by the camera;
obtain a transform image based on the image captured by the camera, wherein the transform image is in a transform domain;
obtain decomposed image components of the transform image, wherein the decomposed image components comprise a low frequency component and at least one high frequency component; and
obtain a reconstructed image based on at least two neural networks processing the decomposed image components in the transform domain.

9. The computing device of claim 8, wherein the one or more processors configured to obtain the transform image based on the image captured by the camera are further configured to:
obtain an image in the transform domain using a Discrete Cosine Transform (DCT).

10. The computing device of claim 9, wherein the one or more processors are further configured to:
obtain a clean reconstructed image by Inverse Discrete Cosine Transform (IDCT) the reconstructed image.

11. The computing device of claim 8, wherein the one or more processors configured to obtain the reconstructed image based on the at least two neural networks processing the decomposed image components in the transform domain are further configured to:
obtain a first reconstructed image by using a first neural network and the low frequency component;
obtain a second reconstructed image by using a second neural network and the at least one high frequency component; and
obtain the reconstructed image by combining the first reconstructed image and the second reconstructed image.

12. The computing device of claim 8, wherein the one or more processors configured to obtain the reconstructed image based on the at least two neural networks processing the decomposed image components in the transform domain are further configured to:
obtain a first reconstructed image by using a first neural network and the low frequency component;
obtain a second reconstructed image by using a second neural network and a first high frequency component, wherein the at least one high frequency component comprises the first high frequency component and a second high frequency component;
obtain a third reconstructed image by using a third neural network and the second high frequency component; and
obtain the reconstructed image by combining the first reconstructed image, the second reconstructed image, and the third reconstructed image.

13. The computing device of claim 8, wherein the at least one high frequency component comprises 15 high frequency components and the at least two neural networks comprise 16 neural networks.

14. The computing device of claim 8, wherein the at least two neural networks comprise a modified Enhanced Deep Super-Resolution (EDSR) network, wherein the modified EDSR network is modified to process a frequency component using a specific pixel residue connection.

15. Anon-transitory computer-readable storage medium storing a plurality of programs for execution by a computing device having one or more processors, wherein the plurality of programs, when executed by the one or more processors, cause the computing device to perform acts comprising:
obtaining an image captured by a camera;
obtaining a transform image based on the image captured by the camera, wherein the transform image is in a transform domain;
obtaining decomposed image components of the transform image, wherein the decomposed image components comprise a low frequency component and at least one high frequency component; and
obtaining a reconstructed image based on at least two neural networks processing the decomposed image components in the transform domain.

16. The non-transitory computer-readable storage medium of claim 15, wherein the plurality of programs further cause the computing device to perform:
obtaining an image in the transform domain using a Discrete Cosine Transform (DCT).

17. The non-transitory computer-readable storage medium of claim 16, wherein the plurality of programs further cause the computing device to perform:
obtaining a clean reconstructed image by Inverse Discrete Cosine Transform (IDCT) the reconstructed image.

18. The non-transitory computer-readable storage medium of claim 15, wherein the plurality of programs further cause the computing device to perform:
obtaining a first reconstructed image by using a first neural network and the low frequency component;
obtaining a second reconstructed image by using a second neural network and the at least one high frequency component; and
obtaining the reconstructed image by combining the first reconstructed image and the second reconstructed image.

19. The non-transitory computer-readable storage medium of claim 15, wherein the plurality of programs further cause the computing device to perform:
obtaining a first reconstructed image by using a first neural network and the low frequency component;
obtaining a second reconstructed image by using a second neural network and a first high frequency component, wherein the at least one high frequency component comprises the first high frequency component and a second high frequency component;
obtaining a third reconstructed image by using a third neural network and the second high frequency component; and
obtaining the reconstructed image by combining the first reconstructed image, the second reconstructed image, and the third reconstructed image.

20. The non-transitory computer-readable storage medium of claim 15, wherein the at least one high frequency component comprises 15 high frequency components and the at least two neural networks comprise 16 neural networks.

21. The non-transitory computer-readable storage medium of claim 15, wherein the at least two neural networks comprise a modified Enhanced Deep Super-Resolution (EDSR) network, wherein the modified EDSR network is modified to process a frequency component using a specific pixel residue connection.
